(19) United States
(12) Patent Application Publication
(10) Pub. No.: US 2005/0068345 A1
(43) Pub. Date: Mar. 31, 2005

(54) Information recording/reproduction apparatus, information recording/reproduction method, information recording/reproduction program and information recording medium on which the information recording/reproduction program is recorded

(75) Inventors: Hiromasa Obata, Tokorozawa-shi (JP); Kenichirou Sumida, Tokorozawa-shi (JP); Kouichi Yazawa, Tokorozawa-shi (JP); Atsushi Sugihara, Tokorozawa-shi (JP); Hidehiro Ishii, Tokorozawa-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/953,417

(22) Filed: Sep. 30, 2004

(30) Foreign Application Priority Data
Sep. 30, 2003 (JP) P2003-341486

(51) Int. Cl. G09G 5/10

(52) U.S. Cl. 345/690

(57) ABSTRACT

The information reproduction apparatus is provided with: a reproduction device which reproduces information; a reproduction-display device of displaying the reproduction information of said reproduction device; and a control device which increases the brightness of said reproduction-display device when reproduction is started by said reproduction device.

### BACKGROUND OF THE INVENTION

1. Field of the Invention

This invention relates to an information recording apparatus, information recording method, information recording program and an information recording medium on which the information recording program is recorded, and more particularly to an information recording apparatus and information recording method for recording a television broadcast program that was obtained by way of a broadcast signal or the like onto a recording medium such as an optical disc or hard disc, and an information recording program and information recording medium on which the information recording program is recorded for recording that information.

2. Description of the Related Art

Conventionally, broadcast programs and the like were recorded continuously 24 hours a day onto a HD (Hard Disc) that was mounted in a so-called information recording/reproduction apparatus.

It is possible for the operator to view information such as a recorded broadcast program anytime by way of a CRT (Cathode Ray Tube) that is connected to the information recording/reproduction apparatus.

With this conventional information recording/reproduction apparatus, by making it possible to continuously record or reproduce information 24-hours a day, there is no power switch in order to prevent interruptions in recording due to mistakes in operation.

However, in the conventional information recording/reproduction apparatus having the construction described above, information not required by the operator was displayed on the display of the information recording/reproduction apparatus 24 hours a day since the recording process was continuous 24 hours a day. As a result, there were problems in that the life of the display unit was shortened, and power was consumed unnecessarily.

### SUMMARY OF THE INVENTION

Taking into consideration the inconveniences mentioned above, the object of this invention is to provide an information recording apparatus, information recording method, information recording program for recording that information and an information recording medium on which the information recording program is recorded that are capable of lengthening the life of the display unit and reducing power consumption.

The above object of the present invention can be achieved by an information reproduction apparatus of the present invention. The information reproduction apparatus is provided with: a reproduction device which reproduces information; a reproduction-display device of displaying the reproduction information of the reproduction device; and a control device which increases the brightness of the reproduction-display device when reproduction is started by the reproduction device.

According to the present invention, by controlling the brightness of a display unit of the information recording/reproduction apparatus, it is possible to clearly check the reproduction state when the operator desires to know the reproduction state since the brightness of an FL display unit of the information recording/reproduction apparatus increases only when reproduction is being performed. Also, since the brightness of the FL display unit increases only during reproduction, it is possible to maintain the life of the FL display unit for a long time. Furthermore, by controlling the brightness of the display unit of the information recording/reproduction apparatus, the brightness of the FL display unit of the information recording/reproduction apparatus increases when reproduction is performed, so it is possible to clearly check the reproduction state when the operator desires to know the reproduction state. Also, since the brightness of the FL display unit is increased only during reproduction, it becomes possible to maintain the life of the FL display unit even longer.

In one aspect of the present invention can be achieved by the information reproduction apparatus of the present invention. The information reproduction apparatus of the present invention is, wherein the display brightness of the reproduction-display device is decreased when ending reproduction by the reproduction device.

According to the present invention, by decreasing the brightness of an FL display unit when reproduction by a DVD drive apparatus is not performed, and by not performing a display on the FL display unit when not needed by the operator, it is possible to reduce the speed of degradation of the display unit. Also, it is possible to decrease the power consumption by the information reproduction apparatus.

In another aspect of the present invention can be achieved by the information reproduction apparatus of the present invention. The information reproduction apparatus of the present invention is further provided with a timer device which times the time from the start of the reproduction process by the reproduction device; and wherein the control device decreases the brightness of the reproduction-display device after a preset amount of time elapses from the start of reproduction.

According to the present invention, not only does the brightness increase when an FL display unit of the information recording/reproduction apparatus is performing reproduction, but even when an operator goes away from the information recording/reproduction apparatus during the reproduction state and forgets to end reproduction, the brightness of the FL display unit will decrease after a set time has elapsed, so it becomes possible to maintain the life of the reproduction-display device for a longer time.

In further aspect of the present invention can be achieved by the information reproduction apparatus of the present invention. The information reproduction apparatus of the present invention is further provided with: a pause device which is used in order to pause the reproduction process by the reproduction device; and wherein the control device decreases the brightness of the reproduction-display device when the reproduction process is stopped by the pause device.

According to the present invention, by decreasing the brightness of an FL display unit when reproduction by a DVD drive apparatus is not performed, and by not performing a display on the FL display unit when not needed by the operator, it is possible to reduce the speed of degradation of the FL display unit. Also, it is possible to decrease the power consumption by the information recording/reproduction apparatus.

In further aspect of the present invention can be achieved by the information reproduction apparatus of the present invention. The information reproduction apparatus of the present invention is, wherein the control device decreases the brightness of the reproduction-display device when a preset specified amount of time elapsed after reproduction was paused by the pause device.

According to the present invention, not only does the brightness increase when an FL display unit of the information recording/reproduction apparatus is performing reproduction, but even when an operator goes away from the information recording/reproduction apparatus during the reproduction state and forgets to end reproduction, the brightness of the FL display unit will decrease after a set time has elapsed, so it becomes possible to maintain the life of the reproduction-display device for a longer time.

In further aspect of the present invention can be achieved by the information recording/reproduction apparatus of the present invention. The information reproduction apparatus of the present invention is, wherein the control device increases the brightness of the reproduction-display device when the time is a preset specified time, and decreases the brightness of the reproduction-display unit when the time is another preset specified time.

According to the present invention, since the brightness of an FL display unit of the information recording/reproduction apparatus is increased at specified times such as start-up time, or the brightness of the FL display unit is decreased at other specified times such as at the time when the operator goes from home to work, it becomes possible to maintain the life of the FL display unit even longer.

The above object of the present invention can be achieved by an information reproduction method of the present invention. The information reproduction method is provided with: a reproduction process of reproducing information; a reproduction-display process of displaying the reproduction information of the reproduction process; and a control process of increasing the brightness of the reproduction-display process when reproduction starts by the reproduction process.

According to the present invention, by controlling the brightness of a display unit of the information recording/reproduction apparatus, it is possible to clearly check the reproduction state when the operator desires to know the reproduction state since the brightness of an FL display unit of the information recording/reproduction apparatus increases only when reproduction is being performed. Also, since the brightness of the FL display unit increases only during reproduction, it is possible to maintain the life of the FL display unit for a long time. Furthermore, by controlling the brightness of the display unit of the information recording/reproduction apparatus, the brightness of the FL display unit of the information recording/reproduction apparatus increases when reproduction is performed, so it is possible to clearly check the reproduction state when the operator desires to know the reproduction state. Also, since the brightness of the FL display unit is increased only during reproduction, it becomes possible to maintain the life of the FL display unit even longer.

The above object of the present invention can be achieved by an information reproduction program of the present invention. The information reproduction program causes a computer in an information recording apparatus to function as: a reproduction device which reproduces information; a reproduction-display device which displays the reproduction information of the reproduction device; and a control device which increases the brightness of the reproduction-display device when start reproduction by the reproduction device.

According to the present invention, by controlling the brightness of a display unit of the information reproduction apparatus, it is possible to clearly check the reproduction state when the operator desires to know the reproduction state since the brightness of an FL display unit of the information recording/reproduction apparatus increases only when reproduction is being performed. Also, since the brightness of the FL display unit increases only during reproduction, it is possible to maintain the life of the FL display unit for a long time. Furthermore, by controlling the brightness of the display unit of the information recording/reproduction apparatus, the brightness of the FL display unit of the information recording/reproduction apparatus increases when reproduction is performed, so it is possible to clearly check the reproduction state when the operator desires to know the reproduction state. Also, since the brightness of the FL display unit is increased only during reproduction, it becomes possible to maintain the life of the FL display unit even longer.

### BRIEF DESCRIPTION OF THE DRAWINGS

FIG. 1 is a block diagram showing the construction of the information recording/reproduction apparatus of the embodiments of the invention.

FIG. 2 is a flowchart showing the overall operation of a first embodiment of the invention.

FIG. 3 is a flowchart showing the overall operation of a second embodiment of the invention.

FIG. 4 is a flowchart showing the overall operation of a third embodiment of the invention.

### DESCRIPTION OF THE PREFERRED EMBODIMENTS

Next, the preferred embodiments of the invention will be explained based on the drawings. The embodiments described below are for the case in which the invention is applied to an information recording/reproduction apparatus that temporarily records a broadcast program that was received by way of a broadcast signal onto a hard disc, and then transfers and records that information onto a DVD (Digital Versatile Disc).

(I) Overall Construction and Operation

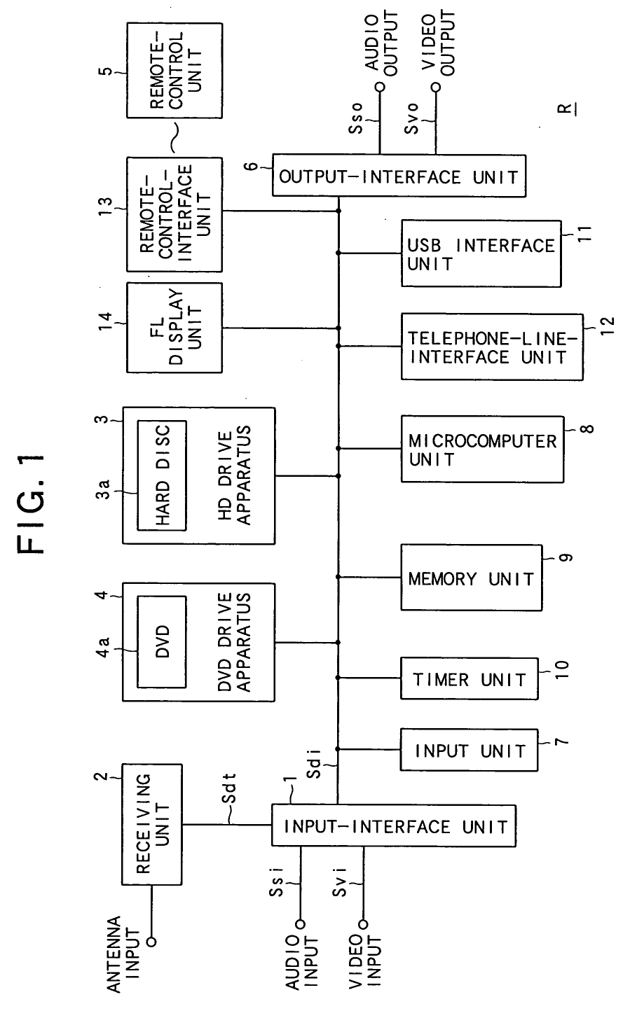

First, FIG. 1 will be used to explain the overall construction of the information recording/reproduction apparatus of the embodiments. FIG. 1 is a block diagram showing the construction of the information recording/reproduction apparatus of the embodiments.

As shown in FIG. 1, the information recording/reproduction apparatus R of the embodiments comprises: an input-interface unit 1; a receiving unit 2 to which an input signal is input from an antenna; an HD-drive apparatus 3 that is capable of recording and reproducing information onto a hard disc 3a as an internal temporary recording medium; a DVD-drive apparatus 4 that is capable of recording and reproducing information onto a DVD 4a as a mounted recording medium; an output-interface unit 6; an input unit 7 as an input device; a microcomputer unit 8 as a control device; a memory unit 9; a timer unit 10; a USB (Universal Serial Bus) interface unit 11; a telephone-line-interface unit 12; a remote-control-interface unit 13; a FL (Fluorescence Light) display unit 14; and a remote-control unit 5.

Next, the overall operation will be explained.

The information recording/reproduction apparatus R of the embodiments of this invention is capable of receiving information such as broadcast programs that are received by way of a broadcast signal (hereafter that information will be referred to as the program), recording that information on either a hard disc 3a or DVD 4a, detecting and reproducing the recorded program from the appropriate medium, and outputting the reproduced information to a FL display or speakers (not shown in the figure).

First, the overall operation in the case where the received program is recorded on a hard disc 3a will be explained.

The broadcast signal that carries the program to be received is received by an antenna ANT, and after the receiving unit 2 performs processing such as demodulation, it output the signal as a received signal Sdt to the input-interface unit 1.

Next, the input-interface unit 1 performs a preset input-interface process on the received signal Sdt and generates a processed-received signal Sdi.

Also, the recording unit (not shown in the figure) inside the HD-drive apparatus records that processed-received signal Sdi onto the hard disc 3a. The received program is recorded on the hard disc 3a in this way.

Next, the overall operation when recording the received program onto a DVD 4a will be explained.

When recording the received program onto a DVD 4a, first, the receiving unit 2 and input-interface unit 1 perform the same processing as in the case described above of recording the received program onto a hard disc 3a, and then output the generated signal to the DVD-drive apparatus 4.

Also, the recording unit (not shown in the figure) inside the DVD-drive apparatus 4 records the generated signal onto the DVD 4a according to a control signal from the microcomputer unit 8. The received program is recorded onto a DVD 4a in this way.

Next, the overall operation when reproducing and outputting the information recorded on the hard disc 3a will be explained. When reproducing and outputting the information recorded on the hard disc 3a, first, the reproduction unit (not shown in the figure) inside the HD-drive apparatus 3 detects the information recorded on the hard disc 3a according to a control signal from the microcomputer unit 8, then generates a detected signal and outputs it to the output-interface unit 6.

After that, the output-interface unit 6 performs a preset output-interface process according to a control signal from the microcomputer unit 8 to generate an audio-output signal Sso and video-output signal Svo, and outputs those signals to a display or speakers (not shown in the figure). The images and audio recorded on the hard disc 3a as information are reproduced in this way.

Finally, the overall operation when reproducing and outputting the information recorded on the DVD 4a will be explained.

When reproducing and outputting the information recorded on the DVD 4a, first, the reproduction unit (not shown in the figure) inside the DVD-drive apparatus 4 detects the information recorded on the DVD 4a according to a control signal from the microcomputer unit 8 and generates a detected signal, then the output-interface unit 6 performs an output-interface process on the detected signal similar to the case described above of reproducing and outputting information recorded on the hard disc 3a to similarly generate an audio-output signal Sso and video-output signal Svo, then outputs those signals to a display or speakers (not shown in the figure). The images or audio recorded on the DVD 4a as information are reproduced in this way.

Here, the control operation for controlling the overall operation described above, is executed using a remote-control unit 5 or an input unit 7 having a button-control unit, and a control signal corresponding to the control operation is output from the input unit 7 or remote-control-interface unit 13 to the microcomputer unit 8.

The microcomputer unit 8 generates control signals for controlling the component units of the information recording/reproduction apparatus R and outputs them to the respective component units in order that the operations corresponding to the executed control operations are executed. Also, after information required for processing by the microcomputer unit 8 has been output to the memory unit 9 and temporarily stored, the memory unit 9 is read again as needed to supply information for processing by the microcomputer unit 8.

When transferring information from the hard disc 3a to the DVD 4a, information is output from the HD-drive apparatus 3 to the DVD-drive apparatus 4 according to a control signal as described above. Also, when transferring information from the DVD 4a to the hard disc 3a, information is similarly output from the DVD-drive apparatus 4 to the HD-drive apparatus 3 according to a control signal as described above.

(II) Embodiment 1

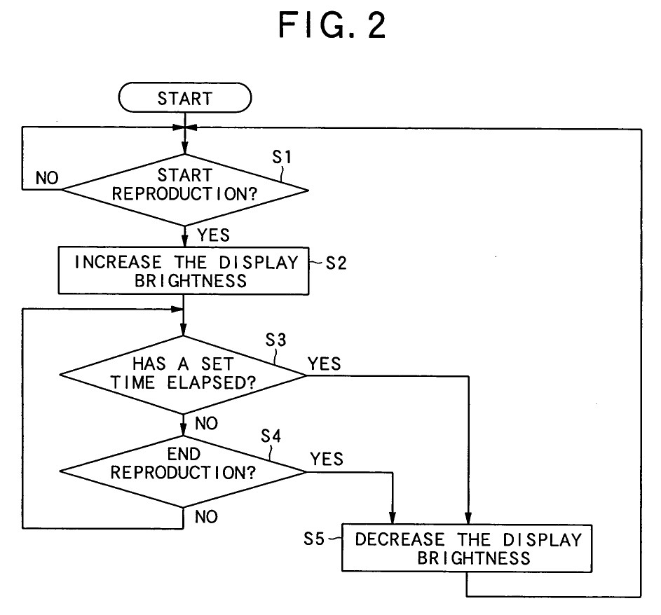

Next, FIG. 2 will be used to explain the reproduction display process of a first embodiment of the invention. FIG. 2 is a flowchart showing the overall recording process of this embodiment.

The embodiment described below is an embodiment that receives the broadcast program, and while it is recorded temporarily on the hard disc 3a, reproduces information recorded on the DVD 4a, and displays the reproduction state on the FL display unit 14.

As shown in FIG. 2, in step S1, when reproducing the information recorded on the DVD 4a (step S1: YES), first, the switch on the input unit 7 or remote-control unit 5 for the desired reproduction is selected. The information for the switch selected on the remote-control unit 5 is input to the microcomputer unit 8 by way of the remote-control-interface unit 13. Also, the information for the switch selected by the input unit 7 is input to the microcomputer unit 8. When a switch for a desired reproduction is not selected by the input unit 7 or remote-control unit 5 (step S1: NO), then the state for detecting the selection of a switch for a desired reproduction using the input unit 7 or remote-control unit 5 is set.

In step S2, when reproducing information recorded on the DVD 4a, in order that the reproduction state display that is displayed on the FL display unit 14 is easier to view, the brightness of the display on the FL display unit 14 is increased according to control from the microcomputer unit 8 (step S2). The reproduction state that is displayed on the FL display unit 14 can include the title of the reproduction information, the elapsed time of the reproduced information, the remaining amount of time of the reproduced information, etc. The information displayed on the FL display unit 14 is not limited to this information, and it is also possible to display the information that is displayed on a normal DVD recording/reproduction apparatus, or the information that is displayed on a normal videotape recording/reproduction apparatus.

In step S3, after starting to reproduce the information recorded on the DVD 4a, the process determines whether or not a preset amount of time has elapsed. When the operator leaves the reproduction operation after reproduction has started and before reproduction has ended, or in other words, the object of this operation is to decrease the brightness of the FL display unit 14 when the operator forgets to end reproduction and begins another task. The times that are to be preset can be set from the remote-control unit 5 or the input unit 7. These values are set in the memory unit 9 and the timer unit 10 performs the clock.

In step S3, after a set time has elapsed (step S3: YES), the process advances to step S5. Also, in step S3, when the set time has not elapsed (step S3: NO), the process advances to step S4.

In step S4, the process determines whether or not reproduction of the information recorded on the DVD 4a has ended. When reproduction of the information recorded on the DVD 4a has ended, or when end-of-reproduction information is input to the microcomputer unit 8 from the remote-control unit 5 or input unit 7 and the microcomputer unit 8 detects the end of reproduction (step S4: YES), the process advances to step S5. Also, when reproduction of the information recorded on the DVD 4a has not finished, or where there is no end-of-reproduction information input to the microcomputer unit 8 from the remote-control unit 5 and input unit 7 (step S4: NO), the process returns to step S3.

In step S5, the brightness of the FL display unit 14 is decreased by control from the microcomputer unit 8. After that, the process goes to step S1. In other words, by keeping the brightness of the FL display unit 14 lowered or by not displaying anything on the FL display unit 14 when not needed by the operator until reproducing information that is recorded on the DVD 4a, it is possible to slow the speed of degradation of the FL display unit 14. Also, it is possible to decrease the power consumption of the information recording/reproduction apparatus R.

In the explanation above, the case of reproducing information recorded on a DVD 4a was explained, however, the invention is not limited to this, and it is possible to apply the invention to the case of reproducing information recorded on a hard disc 3a, or to the case of directly reproducing information received from the receiving unit 2.

As was explained above, by controlling the brightness of the display unit of the information recording/reproduction apparatus R of this embodiment, it is possible to clearly check the reproduction state when the operator desires to know the reproduction state since the brightness of the FL display unit 14 of the information recording/reproduction apparatus R increases only when reproduction is being performed. Also, since the brightness of the FL display unit 14 increases only during reproduction, it is possible to maintain the life of the FL display unit 14 for a long time.

Furthermore, not only does the brightness increase when the FL display unit 14 of the information recording/reproduction apparatus R is performing reproduction, but even when the operator goes away from the information recording/reproduction apparatus R during the reproduction state and forgets to end reproduction, the brightness of the FL display unit 14 will decrease after a set time has elapsed, so it becomes possible to maintain the life of the reproduction-display device for a longer time.

(III) Embodiment 2

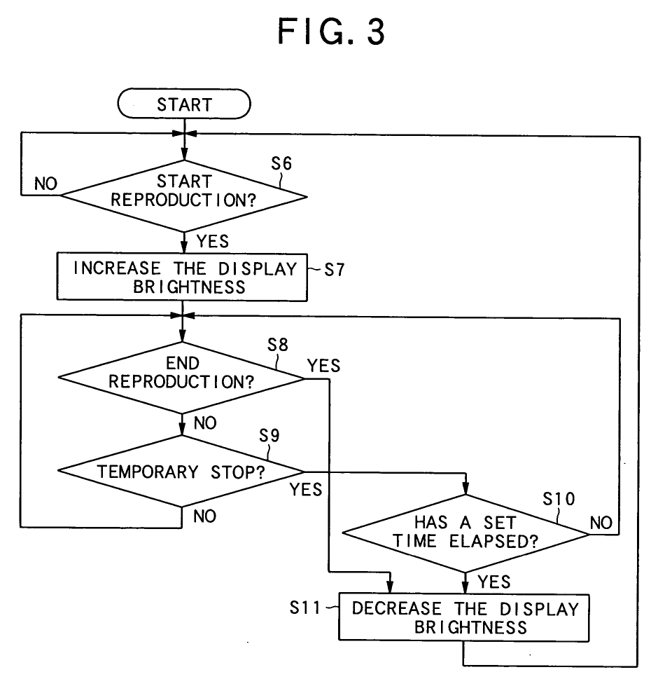

Next, FIG. 3 will be used to explain the information-reproduction-state-display process of a second embodiment of the invention. FIG. 3 is a flowchart showing the overall recording process of this second embodiment.

The embodiment described below is an embodiment that receives a broadcast program, and while that program is temporarily recorded on a hard disc 3a, reproduces information that is recorded on a DVD 4a, and displays the reproduction state on an FL display unit 14.

As shown in FIG. 2, in step S6, when reproducing information that is recorded on the DVD 4a (step S6: YES), first, a switch desiring reproduction is selected using the input unit 7 or remote-control unit 5. The information for the switch selected using the remote-control unit 5 is input to the microcomputer unit 8 by way of the remote-control-interface unit 13. Also, the information for the switch selected using the input unit 7 is input to the microcomputer unit 8. When no switch desiring reproduction is selected using the input unit 7 or remote-control unit 5 (step S6: NO), the state for detecting selection of a switch desiring reproduction using the input unit 7 or remote-control unit 5 is set.

In step S7, when reproducing information that is recording on the DVD 4a, in order to make it easier for the operator to view the display of the reproduction-state of the DVD-drive apparatus 4 that is displayed on the FL display unit 14, the display brightness of the FL display unit 14 is increased by control from the microcomputer unit 8. The display of the reproduction state of the DVD-drive apparatus that is displayed on the FL display unit 14 may include the title of the reproduced information, the amount of elapsed time of the reproduced data, the amount of time remaining of the reproduced data, etc. The information displayed on the FL display unit 14 is not limited to this information, and it is also possible to display information that is displayed by a normal DVD recording/reproduction apparatus, or information that is displayed by a normal videotape recording/reproduction apparatus.

In step S8, the process determines whether or not to end reproduction of the information recorded on the DVD 4a. The microcomputer unit 8 detects whether a switch to end reproduction has been selected from the input unit 7 or remote-control unit 5. After reproduction has ended, information is no longer displayed on the FL display unit 14, so the process determines whether or not to decrease the brightness of the FL display unit 14.

In step SB, when reproduction has ended (step S8: YES), the process advances to step S1, and decreases the brightness of the FL display unit 14. However, in step S8, when reproduction has not ended (step S8: NO), the process advances to step S9.

In step S9, the process determines whether or not reproduction of the information recorded on the DVD 4a has been stopped temporarily. The purpose for this is to decrease the brightness of the FL display unit when the operator leaves the reproduction operation after reproduction has started and before reproduction ends and forgets to end reproduction before starting a different task. The different task could include the case in which the operator must temporarily place all attention on a task that corresponds to a visitors needs, or the case in which there is a telephone call and the operator must place all attention on a task corresponding to it.

When temporary-reproduction-stop information is input to the microcomputer unit 8 from the remote-control unit 5 or input unit 7, and the microcomputer unit 8 detects a temporary stop (step S9: YES), the process advances to step S10. Also, when the reproduction of information recorded on the DVD 4a is not stopped temporarily and temporary-reproduction-stop information is not input to the microcomputer unit 8 from the remote-control unit 5 or input unit 7 (step S9: NO), the process returns to step S8, and detects again whether reproduction-end information has been input to the microcomputer unit from the remote-control unit 5 or input unit 7.

In step S10, the process determines whether or not a preset amount of time has elapsed from when reproduction of the information recorded on the DVD4 a was temporarily stopped. The purpose for this is to decrease the brightness of the FL display unit 14 when the operator leaves the reproduction operation after reproduction was temporarily stopped without ending reproduction, and forgets to end reproduction before starting another task. This is because when the operator has started another task there is no more need to display the reproduction state on the FL display unit 14. The set times to be preset can be set from the remote-control unit 5 or the input unit 7. These values are set in the memory unit 9 and the timer unit 10 performs the clock.

In step S10, when the set time as elapsed (step S10: YES), the process advances to step S11, and decreases the brightness of the FL display unit 14. However, in step S10, when the set time has not elapsed (step S10: NO), the process advances to step S8, and again detects whether reproduction-end information has been input to the microcomputer unit 8 from the remote-control unit 5 or input unit 7.

In step S1, the brightness of the FL display unit 14 is decreased by control from the microcomputer unit 8. After that, the process advances to step S6. In other words, the brightness of the FL display unit 14 is kept low until information recorded on the DVD 4a is reproduced. By decreasing the brightness of the FL display unit 14 when reproduction by the DVD drive apparatus 4 is not performed, and by not performing a display on the FL display unit 14 when not needed by the operator, it is possible to reduce the speed of degradation of the FL display unit 14. Also, it is possible to decrease the power consumption by the information recording/reproduction apparatus R.

As was explained above, by controlling the brightness of the display unit of the information recording/reproduction apparatus R of this embodiment, since the brightness of the FL display unit 14 of the information recording/reproduction apparatus R increases only when reproduction is being performed, it is possible to clearly check the reproduction state when the operator desires to know the reproduction state. Also, since the brightness of the FL display unit 14 increases only during reproduction, it is possible to maintain the life of the FL display unit 14 for a long time.

Furthermore, not only does the brightness increase when the FL display unit 14 of the information recording/reproduction apparatus R is performing reproduction, but even when the operator goes away from the information recording/reproduction apparatus R during the reproduction state and forgets to end reproduction, the brightness of the FL display unit 14 will decrease after a set time has elapsed, so it becomes possible to maintain the life of the reproduction-display device for a longer time.

(IV) Embodiment 3

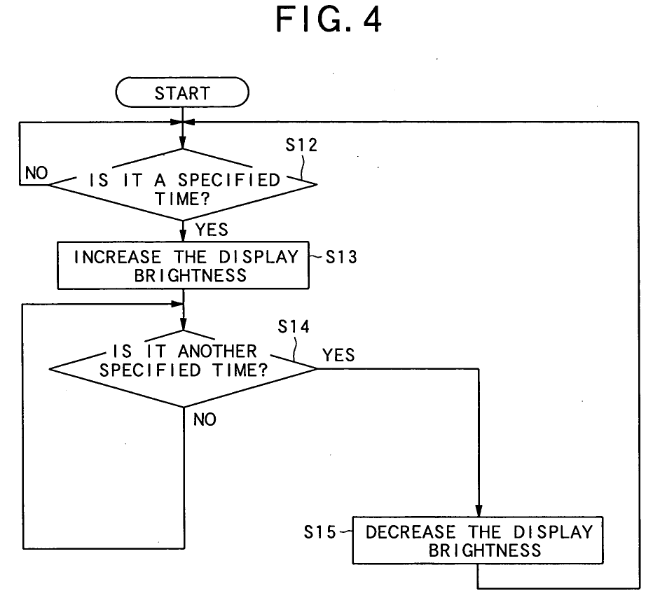

Next, FIG. 4 will be used to explain the information-reproduction-state-display process of a third embodiment. FIG. 4 is a flowchart showing the overall recording process of this third embodiment.

The embodiment described below is an embodiment that receives a broadcast program, and while that program is temporarily recorded on a hard disc 3a, reproduces information that is recorded on a DVD 4a, and displays the reproduction state on an FL display unit 14.

As shown in FIG. 4, in step S12, the timer unit 10 performs the clock function, and the process determines whether or not the time is a preset time. When the time is the preset time (step S12: YES), the process advances to step S13 and increases the display brightness of the FL display unit 14. However, when the time is not the preset specified time (step S12: NO), the process returns to step S12 until the time is the preset specified time.

The setting for this specified time is set in the memory unit 9 according to an instruction from the input unit 7 or remote-control unit 5. Also, this specified time can be set to correspond to different standard time zones according to region. It is not only possible for the operator to set the specified time and standard time zone, but they can also be set at the factory when shipping the information recording/reproduction apparatus R of this invention. This specified time could be set to the time when the operator operates the information recording/reproduction apparatus R of this invention or to the time of the sunset in the region where the information recording/reproduction apparatus R is installed.

In step S14, the process determines whether or not the time is another preset specified time. When the time is another preset specified time (step S12: YES), the process advances to step S15 and decreases the brightness of the FL display unit 14. However, when the time is not another preset specified time (step S12: NO), the process repeats step S14 until the time is that preset specified time.

The setting for this other specified time is set in the timer unit according to an instruction from the input unit 7 or remote-control unit 5. Also, this specified time can be set to correspond to different standard time zones according to region. It is not only possible for the operator to set the specified time and standard time zone, but they can also be set at the factory when shipping the information recording/reproduction apparatus R of this invention. This specified time could be set to the time when the operator ends operation of the information recording/reproduction apparatus R of this invention or to the time of the sunrise in the region where the information recording/reproduction apparatus R is installed.

As was explained above, by decreasing the brightness of the FL display unit 14 when reproduction by the DVD drive apparatus 4 is not performed, and by not performing a display on the FL display unit 14 when not needed by the operator, it is possible to reduce the speed of degradation of the FL display unit 14. Also, it is possible to decrease the power consumption by the information recording/reproduction apparatus R.

Moreover, since the brightness of the FL display unit 14 of the information recording/reproduction apparatus R is increased at specified times such as start-up time, or the brightness of the FL display unit 14 is decreased at other specified times such as at the time when the operator goes from home to work, it becomes possible to maintain the life of the FL display unit 14 even longer.

Furthermore, by controlling the brightness of the display unit of the information recording/reproduction apparatus R of this embodiment, the brightness of the FL display unit 14 of the information recording/reproduction apparatus R increases when reproduction is performed, so it is possible to clearly check the reproduction state when the operator desires to know the reproduction state. Also, since the brightness of the FL display unit 14 is increased only during reproduction, it becomes possible to maintain the life of the FL display unit 14 even longer.

In the embodiments of the invention explained above, the case of increasing the display brightness of the FL display unit 14 when performing reproduction by the DVD-drive apparatus 4 was explained, however, increasing the display brightness of the FL display unit 14 is not limited to when performing reproduction by the DVD-drive apparatus 4. For example, it is also possible to increase the display brightness of the FL display unit 14 when performing reproduction by the HD-drive apparatus 3. In that case, the HD-drive apparatus reproduces information from a hard disc 3a based on a start-reproduction signal from the remote-control unit 5 or input unit 7 while recording a signal Sdi that is input from the antenna and received by way of the input-interface unit 1. This reproduction state is displayed on the FL display unit 14 whose display brightness is increased.

Also, devices connected to the information recording/reproduction apparatus can include CD drives such as a CD (Compact Disc)-R (Recordable) drive, a CD-RW (Rewritable) drive, or CD-ROM (Read Only Memory) drive, or a CD drive that can record or reproduce MP3 (MPEG-1 Audio Layer3). The devices, can also be connected directly to the microcomputer unit 8, or can be connected by way of a USB-interface unit 11 or telephone-line-interface unit 12. Moreover, the embodiments of this invention can also be applied to the case of reproducing from the recording media that can be used by these devices by the DVD-drive apparatus 4.

Furthermore, this invention can be applied when the two media of the information recording/reproduction apparatus R are both a hard disc 3a, or a DVD 4a, or when the program is transferred from one to the other.

In addition, it is possible for at least one of the recording media to be a semiconductor memory or magnetic memory. In other words, needless to say, the invention is not influenced by the type of recording medium, and all kinds of recording media can be used.

By recording programs that correspond to the flowcharts shown in FIG. 2 and FIG. 3 onto an information recording medium such as a flexible disc, or by obtaining those programs via a network such as the Internet and recording them, and then using a general-purpose microcomputer to read and execute them, it is possible to use the microcomputer unit 8 of the embodiments as that general-purpose microcomputer.

Furthermore, the case of using an FL as the display unit of the invention was explained, however, the invention is not limited to an FL display. For example, the invention can also be applied to the case of using a display unit that uses a blue LED (Light Emitting Diode) or EL (Electro Luminescent), or a display unit that uses an LCD (Liquid Crystal Display), and the type of display unit is not limited.

It should be understood that various alternatives to the embodiment of the invention described herein may be employed in practicing the invention. Thus, it is intended that the following claims define the scope of the invention and that methods and structures within the scope of these claims and their equivalents be covered thereby.

The entire disclosure of Japanese Patent Application No. 2003-341486 filed on Sep. 30, 2003 including the specification, claims, drawings and summary are incorporated herein by reference in its entirety.

1. An information reproduction apparatus comprising:
a reproduction device which reproduces information;
a reproduction-display device of displaying the reproduction information of said reproduction device; and
a control device which increases the brightness of said reproduction-display device when reproduction is started by said reproduction device.

2. The information reproduction apparatus according to claim 1 wherein
the display brightness of said reproduction-display device is decreased when ending reproduction by said reproduction device.

3. The information reproduction apparatus according to claim 1 further comprising a timer device which times the time from the start of the reproduction process by said reproduction device; and wherein
said control device decreases the brightness of said reproduction-display device after a preset amount of time elapses from said start of reproduction.

4. The information reproduction apparatus according to claim 1 further comprising:
a pause device which is used in order to pause the reproduction process by said reproduction device; and wherein
said control device decreases the brightness of said reproduction-display device when said reproduction process is stopped by said pause device.

5. The information reproduction apparatus according to claim 4 wherein
said control device decreases the brightness of said reproduction-display device when a preset specified amount of time elapsed after reproduction was paused by said pause device.

6. The information reproduction apparatus according to claim 1 wherein
said control device increases the brightness of said reproduction-display device when the time is a preset specified time, and decreases the brightness of said reproduction-display unit when the time is another preset specified time.

7. An information reproduction method comprising:
a reproduction process of reproducing information;
a reproduction-display process of displaying the reproduction information of said reproduction process; and
a control process of increasing the brightness of said reproduction-display process when reproduction starts by said reproduction process.

8. An information reproduction program causes a computer in an information recording apparatus to function as:
a reproduction device which reproduces information;
a reproduction-display device which displays the reproduction information of said reproduction device; and
a control device which increases the brightness of said reproduction-display device when start reproduction by said reproduction device.

9. An information recording medium in which an information reproduction program is recorded in a readable way by a computer included in an information reproduction apparatus, the information reproduction program causing the computer to function as:
a reproduction device which reproduces information;
a reproduction-display device which displays the reproduction information of said reproduction device; and
a control device which increases the brightness of said reproduction-display device when start reproduction by said reproduction device.
